(19) United States
(12) Patent Application Publication
(10) Pub. No.: US 2008/0232827 A1
(43) Pub. Date: Sep. 25, 2008

(54) IMAGE FORMING APPARATUS AND IMAGE FORMING METHOD

(75) Inventors: Masao Yamaguchi, Tokyo (JP); Haruhiko Ishida, Tokyo (JP); Sunao Tabata, Mishima-shi (JP); Takahiro Fuchigami, Yokosuka-shi (JP); Hiroyuki Kato, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/689,776

(22) Filed: Mar. 22, 2007

(51) Int. Cl. G03G 15/00

(52) U.S. Cl. 399/16

(57) ABSTRACT

An image forming apparatus and an image forming method in the invention include a scanner unit, an image forming unit, and a discarding unit. When time during which a recording medium having an image formed thereon is discharged to a paper discharge tray has exceeded a set time set in advance, the recording medium is discarded to the discarding unit to prevent the recording medium from being inspected by a third party and secure confidentiality.

### BACKGROUND OF THE INVENTION

1. Field of the Invention

The present invention relates to an image forming apparatus and an image forming method for discarding a recording medium left unattended for a set time after an image is recorded thereon.

2. Description of the Related Art

In recent years, there is rapidly increasing interest in security for preventing information centering on individual information from being leaked. In particular, there is rapidly increasing interest in security for a recording medium left unattended when, for example, an image forming apparatus such as a facsimile apparatus or a printer forms received image information thereon as an image.

In general, an image forming apparatus discharges recording media to a paper discharge unit such as a tray or a bin after forming images thereon. A user takes out the recording media discharged to this paper discharge unit. However, it may take time for the user to pick up the recording media because of the user's own reason. It is likely that these images formed on the recording media are inspected or, although not intentionally, carried away by a third party even if, for example, information treated as confidential is formed in the images. Consequently, it is likely that the information formed in the images leaks. As the time until the user picks up the recording media having the images formed thereon becomes longer in this way, it is more likely that the information desired to be treated as confidential leaks.

Therefore, image forming apparatuses that prevent recording media discharged to paper discharge units from being inspected by a third party to secure confidentiality are disclosed in JP-A-2004-284081, JP-A-2005-089040, and JP-A-2005-144845.

The image forming apparatus disclosed in JP-A-2004-284081 includes means for measuring time elapsed after a sheet having an image formed thereon is discharged, means for determining whether a predetermined time has elapsed after the sheet is discharged, conveying means for conveying the sheet to image forming means when it is determined that the predetermined time has elapsed, and storing means for storing one or plural image data for overwriting. The image forming apparatus overwrites the image data for overwriting on an image on the sheet when the predetermined time has elapsed.

The image forming apparatus disclosed in JP-A-2005-089040 includes a paper discharge unit including a tray exclusive for discard that stores a print-outputted print in order to discard the print, presence-or-absence detecting means for detecting the print discharged to the paper discharge unit, counting means for counting time during which the print stays in the paper discharge unit, and a system controller that performs control for moving the print to the tray exclusive for discard when the time during which the print stays in the paper discharge unit has exceeded a predetermined time.

The image forming apparatus disclosed in JP-A-2005-144845 includes writing means for writing job information concerning image processing of the image forming apparatus in a non-contact IC provided in a recording sheet having an image recorded thereon, readout means for reading out the job information written by the writing means from the non-contact IC, searching means for searching for a notification destination on the basis of the job information read out by the readout means, and notifying means for notifying the notification destination found by the searching means that the recording sheet subjected to image formation processing is left unattended.

### BRIEF SUMMARY OF THE INVENTION

The present invention provides an image forming apparatus including an image forming unit that forms an image on a recording medium, a conveying unit that conveys the recording medium having the image formed thereon by the image forming unit, a paper discharge unit to which the recording medium conveyed by the conveying unit is discharged, a detecting unit that detects the recording medium discharged to the paper discharge unit, a measuring unit that measures time during which the detecting unit detects the recording medium, and a discarding unit that discards the recording medium when the time measured by the measuring unit has exceeded a set time set in advance, a recording medium discarding mechanism including a paper discharge unit to which a recording medium having an image formed thereon by an image forming unit is discharged, a detecting unit that detects the recording medium discharged to the paper discharge unit, a measuring unit that measures time during which the detecting unit detects the recording medium, and a discarding unit that discards the recording medium when the time measured by the measuring unit has exceeded a set time set in advance, an image output system including an image forming unit that forms an image on a recording medium, a conveying unit that conveys the recording medium having the image formed thereon by the image forming unit, a paper discharge unit to which the recording medium conveyed by the conveying unit is discharged, a detecting unit that detects the recording medium discharged to the paper discharge unit, a measuring unit that measures time during which the detecting unit detects the recording medium, a discarding unit that discards the recording medium when the time measured by the measuring unit has exceeded a set time set in advance, and an output unit that causes the image forming unit to output the image via a LAN, and an image forming method of forming an image on a recording medium, conveying the recording medium having the image formed thereon, discharging the recording medium conveyed, detecting the recording medium discharged, measuring time during which the recording medium is detected, and discarding the recording medium when the time measured has exceeded a set time set in advance.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram schematically showing a structure of an image forming apparatus in a first embodiment according to the invention;

FIG. 2 is a schematic diagram schematically showing a connection relation between the image forming apparatus and PCs;

FIG. 3 is a block diagram showing functions of the image forming apparatus;

FIG. 4 is a flowchart in discarding a recording medium having an image formed thereon in the first embodiment;

FIG. 5 is a schematic diagram schematically showing a structure of an image forming apparatus in a second embodiment;

FIG. 6 is a flowchart in discarding a recording medium having an image formed thereon in the second embodiment;

FIG. 7 is a schematic diagram schematically showing a structure of an image forming apparatus in a third embodiment;

FIG. 8 is a flowchart in reusing a recording medium having an image formed thereon in the third embodiment; and

FIG. 9 is a schematic diagram schematically showing a structure of an image forming apparatus according to the invention specialized for discarding a recording medium.

### DETAILED DESCRIPTION OF THE INVENTION

Embodiments of the invention will be hereinafter explained in detail with reference to the drawings. In the following explanation, in the figure, a conveying direction of a recording medium and a traveling direction of a first carriage and a second carriage described later are set as an X axis direction or a sub-scanning direction. A direction orthogonal to this conveying direction is set as a Y axis direction, a main scanning direction, or a width direction of the recording medium. A direction orthogonal to the X axis and the Y axis directions is set as a Z axis direction or a vertical direction. A path through which the recording medium is conveyed is referred to as a conveying path.

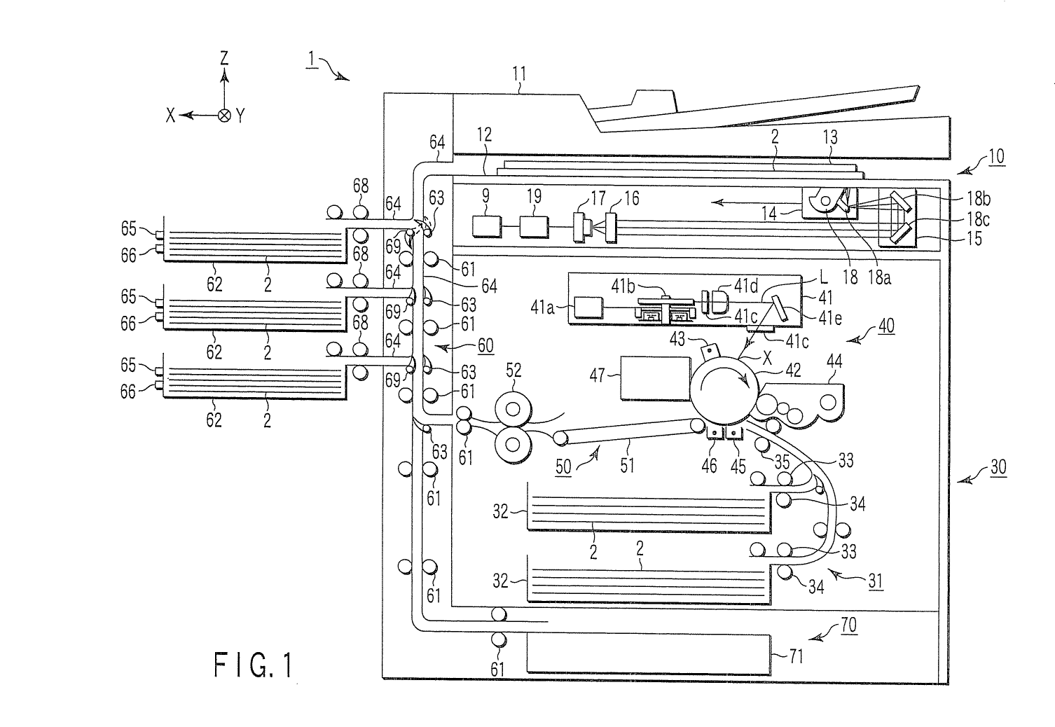

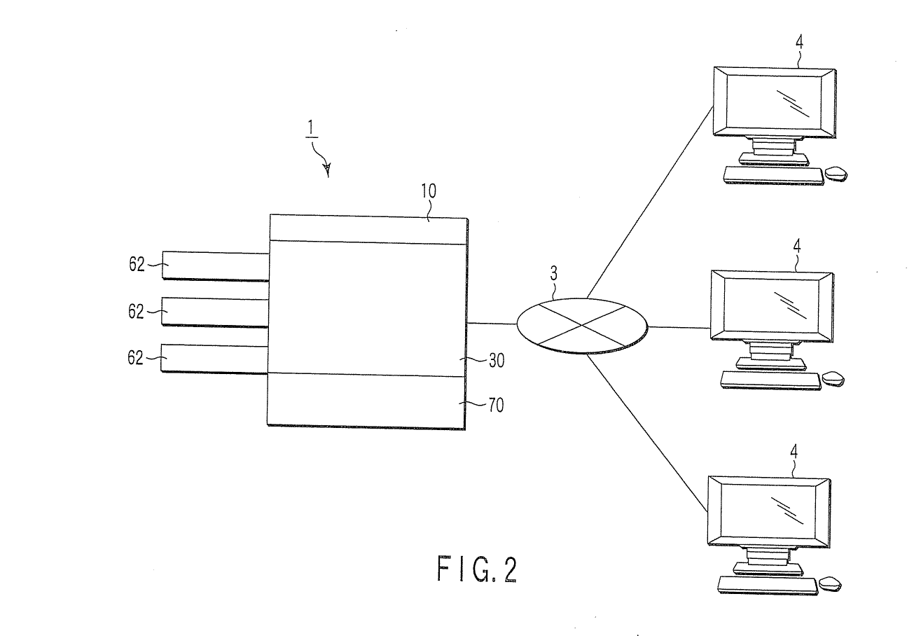

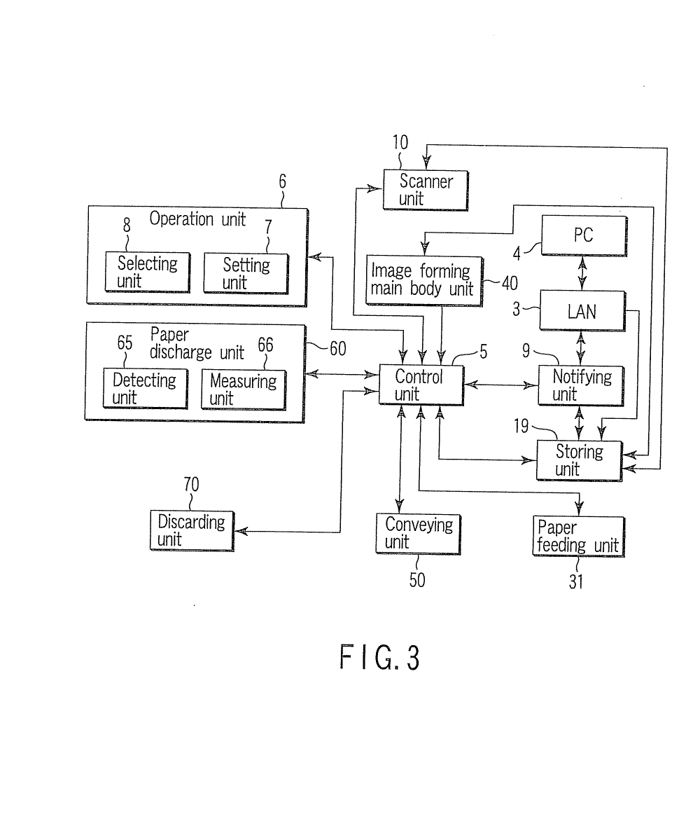

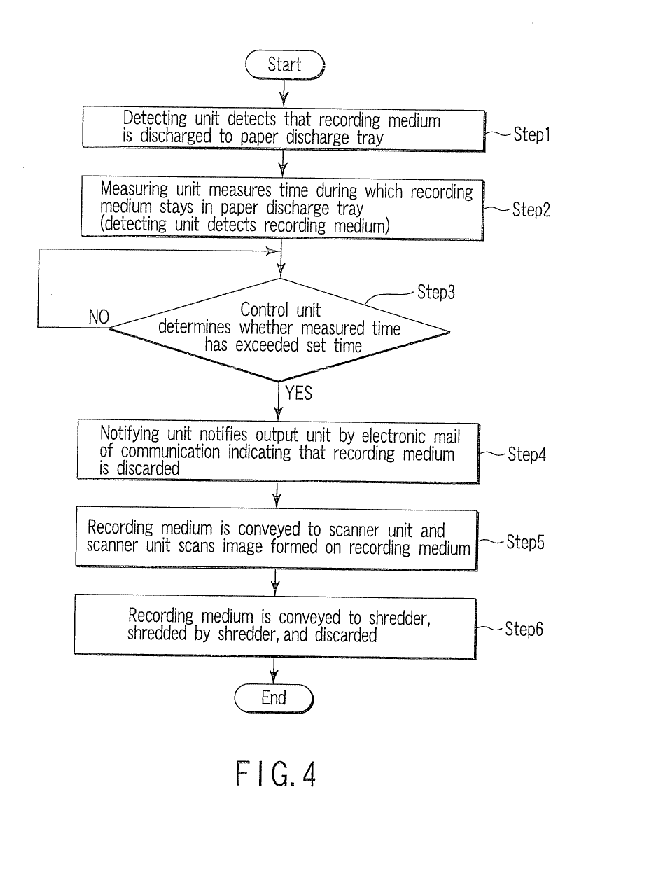

A first embodiment will be explained with reference to FIGS. 1 to 4. FIG. 1 is a schematic diagram schematically showing a structure of an image forming apparatus in this embodiment. FIG. 2 is a schematic diagram schematically showing a connection relation between the image forming apparatus and PCs in this embodiment. FIG. 3 is a block diagram showing functions of the image forming apparatus in this embodiment. FIG. 4 is a flowchart in discarding a recording medium having an image formed thereon in this embodiment.

In FIG. 1, an image forming apparatus 1 according to this embodiment is constituted by, as main units, a scanner unit 10 that scans an image formed on a recording medium 2 and generates image data, an image forming unit 30 that forms an image on the recording medium 2, a paper discharge unit 60 to which the recording medium 2 is discharged, and a discarding unit 70 that discards the recording medium 2.

The scanner unit 10 is provided with an Auto Document Feeder (hereinafter, ADF) 11 that feeds the recording medium 2 placed thereon to downstream, an original stand 12 on which the recording medium 2 fed by the ADF 11 is placed or the recording medium 2 is directly placed, a fixing cover 13 that fixed the recording medium 2 placed on the original stand 12 to the original stand 12, a first carriage 14 that moves for scanning in one direction (the X axis direction) while emitting light to the recording medium 2 placed on the original stand 12 and receiving reflected light from the recording medium 2, a second carriage 15 that moves following the first carriage 14 and reflects the emitted light emitted from the first carriage 14 in a predetermined direction (on a light receiving surface of a photoelectric conversion element 17 described later), an optical lens 16 that focuses reflected light reflected from the second carriage 15, and a photoelectric conversion element 17 such as a CCD sensor that receives the light focused by the optical lens 16 and, then, electrically converts this light and outputs an electric signal.

A position of the first carriage 14 and the second carriage 15 shown in FIG. 1 is referred to as a home position. In the X axis direction, the first carriage 14 is located in front of the second carriage 15. The light emitted from the first carriage 14 scans an image line by line along the Y axis direction. In the X axis direction, the photoelectric conversion element 17 is located in front of the optical lens 16.

The first carriage 14 is provided with a light source 18 that emits light to the recording medium 2 placed on the original stand 12 and a mirror 18a that reflects reflected light from the recording medium 2 to the second carriage 15. In the reflected light from the recording medium 2, light and shade of light corresponding to presence and absence of an image formed on the recording medium 2 are distributed.

The second carriage 15 is provided with mirrors 18b and 18c that reflect the reflected light from the mirror 18a to the optical lens 16.

The photoelectric conversion element 17 receives this reflected light via the optical lens 16. The photoelectric conversion element 17 having received the reflected light electrically converts the reflected light according to light and shade of light of the reflected light and outputs a video signal. A not-shown image processing unit applies various kinds of publicly-known correction processing to this video signal and generates image data. The image processing unit further converts the image data into a laser modulation signal and outputs the laser modulation signal to a storing unit 19. This laser modulation signal is a signal for changing light intensity of a laser beam emitted from a laser light source 41a provided in an optical scanning unit 41 described later to any one of intensity capable of recording an electrostatic latent image and intensity for not recording an electrostatic latent image on an outer peripheral surface of a photoconductive drum 42 to which a predetermined potential is given by a charging unit 43. The storing unit 19 temporarily stores the laser modulation signal (a digital signal or an image). The storing unit 19 is connected to a notifying unit 9 described later.

The image forming unit 30 is provided with a paper feeding unit 31 that feeds a recording medium 2, an image forming main body unit 40 that forms an image on the recording medium 2, and a conveying unit 50 that conveys the recording medium 2.

The paper feeding unit 31 is provided with recording media cassettes 32 capable of storing the recording media 2 of plural kinds and plural sizes, paper feeding rollers 33 and separating rollers 34 that take out (feed) the recording media 2 stored in the recording media cassettes 32 one by one and separate the recording media 2, and aligning rollers 35 that convey the recording medium 2 fed thereto to downstream at predetermined timing.

The image forming main body unit 40 is provided with the optical scanning unit 41, a photoconductive member (hereinafter referred to as photoconductive drum) 42, the charging unit 43, a developing unit 44, a transferring unit 45, a separating unit 46, and a cleaning unit 47. The charging unit 43, the developing unit 44, the transferring unit 45, the separating unit 46, and the cleaning unit 47 are arrayed in order along an arrow direction in which the photoconductive drum 42 is rotated.

The optical scanning unit 41 is provided with a laser light source 41a that emits a laser beam L in response to a digital signal outputted from the storing unit 19, a polygon mirror 41b that deflects this laser beam L at constant angular speed, a dustproof glass 41c that protects the laser beam L deflected by the polygon mirror 41b from dust, an f-θ lens 41d that corrects the laser beam L deflected at the constant angular speed to be deflected at the constant angular speed on the photoconductive drum 42, and a mirror 41e that reflects the laser beam L corrected by the f-θ lens 41d to the photoconductive drum 42. The laser beam L emitted from the optical scanning unit 41 passes between the charging unit 43 and the developing unit 44 and is irradiated on a predetermined position X on the outer peripheral surface of the photoconductive drum 42.

The photoconductive drum 42 of a drum shape is rotated by a not-shown main motor such that the outer peripheral surface thereof moves at a predetermined speed. The laser beam L emitted from the optical scanning unit 41 is irradiated on the outer peripheral surface of the photoconductive drum 42. Consequently, an electrostatic latent image corresponding to the image of the recording medium 2 placed on the original stand 12 is formed on the photoconductive drum 42.

The charging unit 43 charges a potential of a predetermined polarity on the outer peripheral surface of the photoconductive drum 42.

The developing unit 44 selectively supplies a toner as a visualizing material to the electrostatic latent image formed on the photoconductive drum 42 and develops the electrostatic latent image.

The transferring unit 45 gives a predetermined electric field to the toner formed on the outer peripheral surface of the photoconductive drum 42 by the developing unit 44 and transfers the toner onto the recording medium 2 conveyed from the paper feeding unit 31. The separating unit 46 releases the recording medium 2 having the toner transferred thereon by the transferring unit 45 and the toner between the recording medium 2 and the photoconductive drum 42 from electrostatic attraction with the photoconductive drum 42 and separates the recording medium 2 and the toner from the photoconductive drum 42.

The cleaning unit 47 removes (cleans) the toner remaining on the outer peripheral surface of the photoconductive drum 42. Consequently, a potential distribution on the outer peripheral surface of the photoconductive drum 42 returns to a state before the surface potential is supplied by the charging unit 43.

The conveying unit 50 is provided with a conveying mechanism 51 that conveys the recording medium 2 having the electrostatic latent image formed thereon by the photoconductive drum 42 and a fixing unit 52 that fixes the image on the recording medium 2. The fixing unit 52 is a pair of rollers.

The paper discharge unit 60 is provided with conveying roller pairs 61 that convey the recording medium 2 having the image fixed thereon by the fixing unit 52, plural switching units 63 that switch a conveyance destination of the recording medium 2 discharged by the conveying roller pairs 61 to any one of paper discharge trays 62, plural paper discharge trays 62 to which the recording medium 2 conveyed via the switching units 63, a paper discharging and conveying path 64 as a part of the conveying path, and the paper discharging roller pairs 68 is discharged, detecting units 65 that are provided in the paper discharge trays 62 and detect that the recording medium 2 is discharged to the paper discharge trays 62, measuring units 66 that measure time during which the detecting units 65 detect the recording medium 2 (measure time during which the recording medium 2 stays in the paper discharge trays 62), and plural switching units 69 that switch a conveyance destination of the recording medium 2 discharged to the paper discharge trays 62 to the scanner unit 10. The measuring units 66 start the measurement when the detecting units 55 detect the recording medium 2. The paper discharging and conveying path 64 is connected to the original stand 12. When the switching units 63 and 69 are changed over, the recording medium 2 discharged to the paper discharge trays 62 is conveyed to the original stand 12 through the paper discharging and conveying path 64.

The discarding unit 70 is provided with a shredder 71 that shreds the recording medium 2 conveyed through the paper discharging and conveying path 64.

The image forming apparatus in this embodiment causes the scanner unit 10 to scan the image formed on the recording medium 2 placed on the original stand 12 and, then, forms the image on the recording medium 2 with the image forming unit 30. As shown in FIG. 2, the image forming apparatus 1 of this embodiment is connected to plural PCs 4 or the like via a Local Area Network (hereinafter, LAN) 3. In this embodiment, an image is formed on the recording medium 2 on the basis of data received from these PCs 4 or the like.

Functions in this embodiment will be explained with reference to FIG. 3.

The image forming apparatus 1 is provided with a control unit 5. The control unit 5 is connected to an operation unit 6, the scanner unit 10, the storing unit 19, the image forming main body unit 40, the paper discharge unit 60, the notifying unit 9, the discarding unit 70, the conveying unit 50, and the paper feeding unit 31. The control unit 5 controls driving of these units.

The operation unit 6 is provided with a setting unit 7 for selecting a set time and a selecting unit 8 for selecting, when the recording medium 2 is placed on the original stand 12 via the ADF 11 or directly placed on the original stand 12, to which of the PCs 4 an electronic mail transmitted by the notifying unit 9 described later should be transmitted. The operation unit 6 operates the setting unit 7 and the selecting unit 8. The set time is time used as a reference in discarding the recording medium 2.

As described above, the scanner unit 10 moves the first carriage 14 and the second carriage 15 in the X axis direction while causing light emitted from the first carriage 14 to scan along the Y axis direction. Consequently, the scanner unit 10 scans an image of the recording medium 2 fed from the ADF 11, an image of the recording medium 2 conveyed from the paper discharge trays 62 to the original stand 12 by the paper discharging and conveying path 64 when time measured by the measuring unit 66 described later has exceeded the set time, or an image of the recording medium 2 directly placed on the original stand 12. The image scanned is stored in the storing unit 19.

The storing unit 19 stores the image scanned by the scanner unit 10 as described above, an image received from the PC 4 via the LAN 3, recording medium information such as a recording medium name at the time when the image is formed on the recording medium 2, an image formation time, and a discard time, and control programs for an image forming operation, a recording medium scanning operation, and the like in the image forming apparatus 1.

The image forming main body unit 40 forms the image stored in the storing unit 19 on the recording medium 2 fed from the paper feeding unit 31.

The detecting unit 65 provided in the paper discharge unit 60 is an optical sensor. As this optical sensor, for example, a photointerrupter sensor of a non-contact type is used. With this photointerrupter sensor, the detecting unit 65 detects that the recording medium 2 is discharged to the paper discharge tray 62. The optical sensor may be a transmission type or a reflection type. The detecting unit 65 may be a sensor other than the optical sensor. It is also possible to use a mechanical sensor (a contact-type sensor) employing a switch.

The measuring unit 66 provided in the paper discharge unit 60 measures time during which the detecting unit 65 detects the recording medium 2.

When this measured time has exceeded the set time set by the setting unit 7, the control unit 5 conveys the recording medium 2 discharged to the paper discharge tray 62 to the scanner unit 10 through the paper discharging and conveying path 64. The control unit 5 conveys the recording medium 2 scanned by the scanner unit 10 to the discarding unit 70.

When the measured time has exceeded the set time set by the setting unit 7, the notifying unit 9 sends notification to an output unit (the PC 4) selected by the selecting unit 8. The notifying unit 9 may send notification to the output unit (the PC 4) that outputted an instruction to form the image on the recording medium 2 to the image forming unit 30 via the LAN 3.

A content of this notification is communication indicating that the discarding unit 70 discards the recording medium 2 having the image formed thereon. The content of this notification is notified to the output unit by, for example, electronic mail. The recording medium information stored in the storing unit 19 may be added to the content of this notification.

Since the discarding unit 70, the conveying unit 50, and the paper feeding unit 31 are described above, detailed explanations of the units are omitted here.

An image forming operation in this embodiment will be explained.

The recording medium 2 fed to downstream by the ADF 11 is placed on the original stand 12. Alternatively, the recording medium 2 is directly placed on the original stand 12. The recording medium 2 placed is fixed to the original stand 12 by the fixing cover 13.

The control unit 5 causes the first carriage 14 and the second carriage 15 to travel in the X axis direction from the home position shown in FIG. 1. In that case, the first carriage 14 emits light from the light source 18 to the recording medium 2. This light is emitted line by line in order in the X axis direction (along the Y axis direction). In this way, the first carriage 14 scans the recording medium 2. Reflected light from the recording medium 2 is reflected by the mirror 18a, the mirror 18b, and the mirror 18c. The reflected light is focused by the optical lens 16 and, then, received by the photoelectric conversion element 17. Light and shade of light corresponding to presence or absence of an image formed on the recording medium 2 are distributed in this reflected light as described above.

The photoelectric conversion element 17 electrically converts the reflected light received and outputs an electric signal (an analog signal). The analog signal outputted is converted into a digital signal by a not-shown A/D converter. The digital signal is stored in the storing unit 19.

In this way, the scanner unit 10 scans the recording medium 2 placed on the original stand 12 line by line and scans the image.

As described above, the image (a digital signal) of the recording medium 2 placed on the original stand 12 and the image (a digital signal) transmitted from the PC 4 via the LAN are stored in the storing unit 19.

When an image is formed on the recording medium 2, a set time is set by the setting unit 7. A transmission destination of an electronic mail is selected by the selecting unit 8.

An image is outputted from the storing unit 19 to the optical scanning unit 41. The laser light source 41a emits the laser beam L according to the image. The laser beam L emitted is deflected by the polygon mirror 41b. The laser beam L deflected is transmitted through the dustproof glass 41c and the f-θ lens 41d. The laser beam L transmitted is reflected by a mirror 41e. In that case, a surface potential is supplied to the outer peripheral surface of the photoconductive drum 42, which is opposed to the charging unit 43, by the charging unit 43. The reflected light reflected by the mirror 41e passes between the charging unit 43 and the developing unit 44 and is irradiated on the predetermined position X on the outer peripheral surface of the photoconductive drum 42. When the photoconductive drum 42 rotates, the laser beam L is irradiated line by line on the outer peripheral surface of the photoconductive drum 42 as described above. This laser beam L is deflected in a direction identical with a direction of a scanning line of the scanner unit 10 described above (the Y axis direction).

An electrostatic latent image corresponding to the digital signal is formed on the outer peripheral surface (e.g., the predetermined position X) of the photoconductive drum 42. When the photoconductive drum 42 rotates, this electrostatic latent image is formed over the entire outer peripheral surface of the photoconductive drum 42. When the photoconductive drum 42 further rotates, the predetermined position X is opposed to the developing unit 44. Consequently, a toner is supplied from the developing unit 44 to the electrostatic latent image in the predetermined position X and the electrostatic latent image is developed. When the photoconductive drum 42 further rotates, the toner in the predetermined position X is located in a position opposed to the transferring unit 45.

The control unit 5 drives the paper feeding unit 31. Consequently, the recording media 2 are taken out from the recording media cassettes 32 one by one by the paper feeding rollers 33 and the separating rollers 34. The recording medium 2 taken out is aligned in conveyance timing by the aligning roller 35 and, then, conveyed to a space between the photoconductive drum 42 and the transferring unit 45. The toner is given an electric field by the transferring unit 45. Consequently, the toner is transferred onto the recording medium 2.

The recording medium 2 having the toner transferred thereon is separated from the photoconductive drum 42 together with the toner by the separating unit 46. The recording medium 2 separated is conveyed to the fixing unit 52 by the conveying mechanism 51.

The toner is fixed on the recording medium 2, which is conveyed to the fixing unit 52, by heat emitted from the fixing unit 52 and a pressure (own weight) of the fixing unit 52. The recording medium 2 having the toner fixed thereon is discharged by the conveying roller pairs 61. After a conveying destination is switched by the switching units 63, the recording medium 2 passes through the paper discharging and conveying path 64 and is discharged to the paper discharge tray 62 by the paper discharge roller pair 68.

When the photoconductive drum 42, from which the toner is transferred onto the recording medium 2 by the transferring unit 45, further rotates, the predetermined position X is located in a position opposed to the cleaning unit 47. Consequently, the toner remaining in the predetermined position X is removed by the cleaning unit 47 and the photoconductive drum 42 is returned to a state before the surface potential is supplied by the charging unit 43. As a result, it is possible to perform the next image formation.

In this embodiment, the process described above is repeated, which makes it possible to perform continuous image forming operations.

Processing for discarding a recording medium after image formation in this embodiment will be explained with reference to FIG. 4.

The recording medium 2 having the image formed thereon as described above is discharged to the paper discharge tray 62.

In that case, as shown in FIG. 4, the detecting unit 65 detects that the recording medium 2 is discharged to the paper discharge tray 62 (Step 1). At this point, the measuring unit 66 starts measurement. Consequently, time during which the recording medium 2 stays in the paper discharge tray 62 is measured by the measuring unit 66 (Step 2). The control unit 5 determines whether the measured time measured by the measuring unit 66 has exceeded the set time set in advance by the setting unit 7 (Step 3).

When the measured time has exceeded the set time in this determination (Step 3: Yes), the notifying unit 9 notifies an output unit by electronic mail that the recording medium 2 is conveyed to the discarding unit 70 and discarded (Step 4). The output unit is an apparatus, for example, the PC 4, that issued an output instruction to form an image on the recording medium 2 to the image forming unit 30 via the LAN 3 as described above. The notifying unit 9 may add the recording medium information to the communication indicating that the recording medium 2 is discarded and transmit the recording medium information. When the measured time has not exceeded the set time (Step 3: No), the processing returns to Step 3.

Moreover, the control unit 5 drives the switching units 63 and the switching units 69 to switch a conveyance destination of the recording medium 2. Consequently, the recording medium 2 is conveyed to the scanner unit 10 through the paper discharging and conveying path 64. After the recording medium 2 is conveyed to the original stand 12, the scanner unit 10 moves the first carriage 14 and the second carriage 15 in the X axis direction while causing light emitted from the first carriage 14 to scan along the Y axis direction as described above. Consequently, the scanner unit 10 scans the image formed on the recording medium 2 conveyed. The image scanned is stored in the storing unit 19 as described above (Step 5).

The recording medium 2 is conveyed from the original stand 12 to the shredder 71 serving as the discarding unit 70 through the paper discharging and conveying path 64. The shredder 71 shreds the recording medium 2 conveyed and discards the recording medium 2 (Step 6).

As described above, in this embodiment, time during which the recording medium 2 stays in the paper discharge tray 62 is measured. When the measured time has exceeded the set time, an electronic mail is transmitted to the output unit, which outputted an instruction to form an image on the recording medium 2, through the LAN 3. Communication indicating that the recording medium 2 is discarded is described in this electronic mail. Moreover, in this embodiment, the image formed on the recording medium 2 is scanned by the scanner unit 10 after the electronic mail is transmitted and stored. In this embodiment, after the image is stored, the recording medium 2 is shredded by the shredder.

Consequently, in this embodiment, after the set time has elapsed, it is possible to prevent the recording medium 2 having the image formed thereon from being left unattended. Thus, it is possible to prevent, for example, a situation in which an image in which confidential information is formed is inspected by a third party and the confidential information leaks.

The set time can be arbitrarily set by the setting unit 7. Thus, in this embodiment, it is possible to secure higher confidentiality by setting the set time short.

A receiver who has received the electronic mail directly operates the image forming apparatus 1 to cause the image forming apparatus 1 to form the image stored in the storing unit 19 again. Therefore, the receiver can immediately check and receive the recording medium 2. Consequently, in this embodiment, when the receiver receives the electronic mail and, then, operates the PC 4 and causes the image forming apparatus 1 to form the image again, it is possible to prevent a situation in which the set time elapses and the recording medium 2 having the image formed thereon is shredded again.

Further, for example, when a PC operator outputs an instruction for formation of an image to the image forming apparatus 1, the PC operator may erase an image stored in an HDD provided in the PC 4 by mistake. However, when the PC operator needs to form this image again later, in this embodiment, if this image is stored in the storing unit 19, it is possible to easily form an image on the recording medium 2 by diverting this image.

In this embodiment, the electronic mail is transmitted in Step 3 and the recording medium 2 is scanned by the scanner 10 in Step 4. However, the processing of the transmission and the processing of the scanning may be performed in an opposite order or may be performed in parallel. Moreover, until the recording medium 2 is shredded by the shredder after the electronic mail is transmitted, an outputting person (the receiver) may be allowed to fetch the recording medium 2 by setting a certain degree of time.

In this embodiment, the scanner unit 10 scans the image formed on the recording medium 2 after the time during which the recording medium 2 stays in the paper discharge tray 62 exceeds the set time. It is unnecessary to limit time for scanning the image to this (specifically, the scanner unit 10 scans the image until the recording medium is conveyed from the paper discharge unit to the discarding unit). For example, if the control unit 5 is set to check, immediately after an image is formed on the recording medium 2 by the image forming unit 30, whether a transmission destination of the image is designated as a set destination to which confidential information is transmitted and transmits the confidential information, the control unit 5 drives the switching units 63 and the switching units 69 to switch a conveyance destination of the recording medium 2 and convey the recording medium 2 to the scanner unit 10. Consequently, the scanner unit 10 can scan the image immediately after the image is formed by the image forming unit 30.

Consequently, since the image is already stored in the recording medium 2 having the confidential image recorded thereon, in this embodiment, it is unnecessary to convey the recording medium 2 from the paper discharge tray 62 to the discarding unit 70 via the scanner unit 10 after the set time has elapsed and it is possible to directly convey the recording medium 2 from the paper discharge tray 62 to the discarding unit 70.

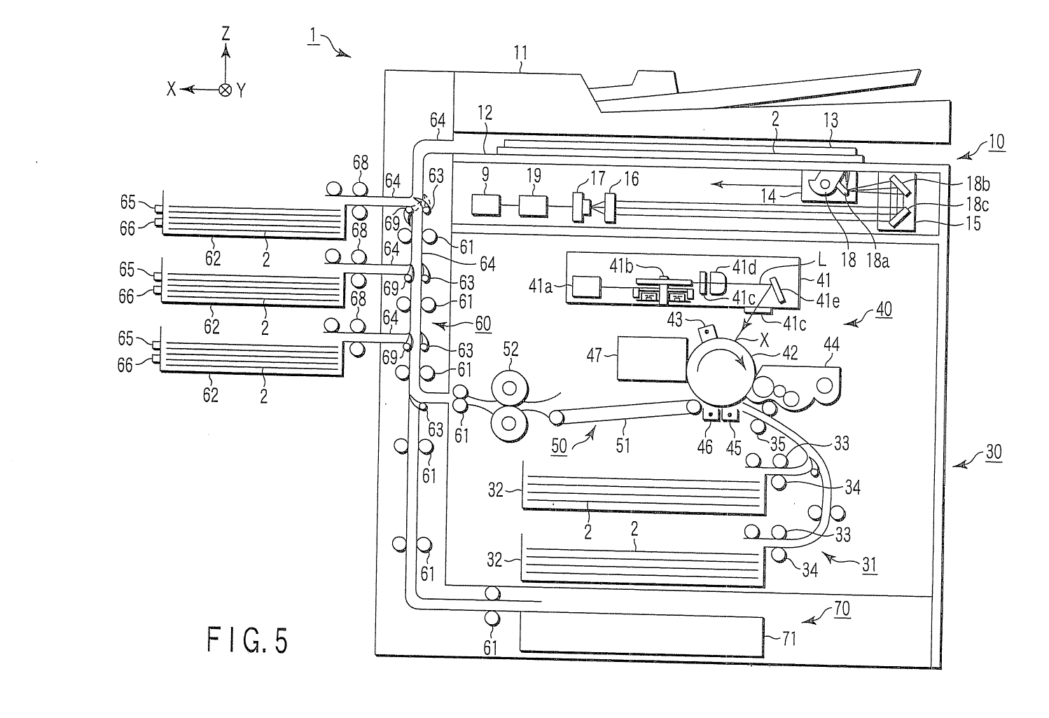

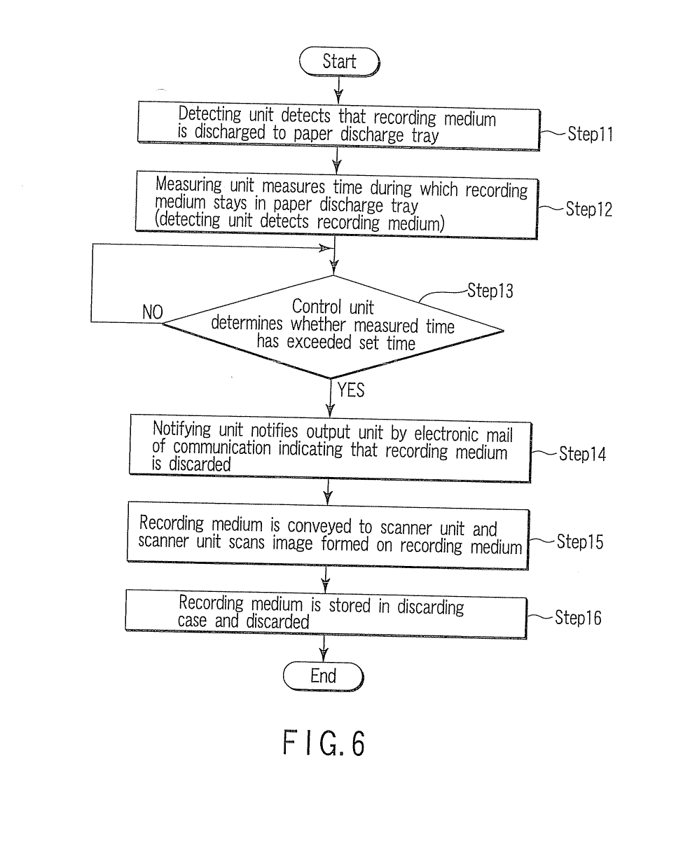

A second embodiment according to the invention will be explained with reference to FIGS. 5 and 6. FIG. 5 is a schematic diagram schematically showing a structure of an image forming apparatus in this embodiment. FIG. 6 is a flowchart in discarding a recording medium having an image formed thereon in this embodiment. Components same as those in the first embodiment described above are denoted by the same reference numerals and signs and detailed explanations of the components are omitted.

Components in this embodiment different from those in the first embodiment will be briefly explained with reference to FIG. 5.

The discarding unit 70 in the first embodiment is the shredder 71. However, the discarding unit 70 in this embodiment is a discarding case 72 that is discarded together with the recording medium 2. The recording medium 2 is discarded together with the discarding case 72.

Processing in discarding a recording medium after image formation in this embodiment will be explained with reference to FIG. 6.

Operations from formation of an image on the recording medium 2 to discharge of the recording medium 2 to the paper discharge tray 62 are omitted because the operations are the same as those in the first embodiment described above.

As described above, the recording medium 2 having the image formed thereon is discharged to the paper discharge tray 62.

In that case, as shown in FIG. 6, the detecting unit 65 detects that the recording medium 2 is discharged to the paper discharge tray 62 (Step 11). At this point, the measuring unit 66 starts measurement. Consequently, time during which the recording medium 2 stays in the paper discharge tray 62 is measured by the measuring unit 66 (Step 12). The control unit 5 determines whether the measured time measured by the measuring unit 66 has exceeded the set time set in advance by the setting unit 7 (Step 13).

When the measured time has exceeded the set time in this determination (Step 13: Yes), the notifying unit 9 notifies an output unit by electronic mail that the recording medium 2 is conveyed to the discarding unit 70 and discarded (Step 14). The notifying unit 9 may add the recording medium information to the communication indicating that the recording medium 2 is discarded and transmit the recording medium information. When the measured time has not exceeded the set time (Step 13: No), the processing returns to Step 13.

Moreover, the control unit 5 drives the switching units 63 and the switching units 69 to switch a conveyance destination of the recording medium 2. Consequently, the recording medium 2 is conveyed to the scanner unit 10 through the paper discharging and conveying path 64. After the recording medium 2 is conveyed to the original stand 12, the scanner unit 10 moves the first carriage 14 and the second carriage 15 in the X axis direction while causing light emitted from the first carriage 14 to scan along the Y axis direction as described above. Consequently, the scanner unit 10 scans the image formed on the recording medium 2 conveyed. The image scanned is stored in the storing unit 19 as described above (Step 15).

The recording medium 2 is conveyed from the original stand 12 to the discarding case 72 serving as the discarding unit 70 through the paper discharging and conveying path 64. When a predetermined number of recording media 2 discarded has accumulated in the discarding case 72, the discarding case 72 having the recording media 2 stored therein is discarded (Step 16).

The processing from Step 11 to Step 15 is the same as the processing from Step 1 to Step 5 in the first embodiment described above.

Consequently, in this embodiment, it is possible to obtain effects same as those in the first embodiment described above. In this embodiment, it is possible to lock the discarding case 72. Consequently, since the discarding case 72 is locked, it is impossible for a third party not having a key to take out the recording medium 2 conveyed to the discarding case 72. In this way, in this embodiment, it is possible to secure higher confidentiality.

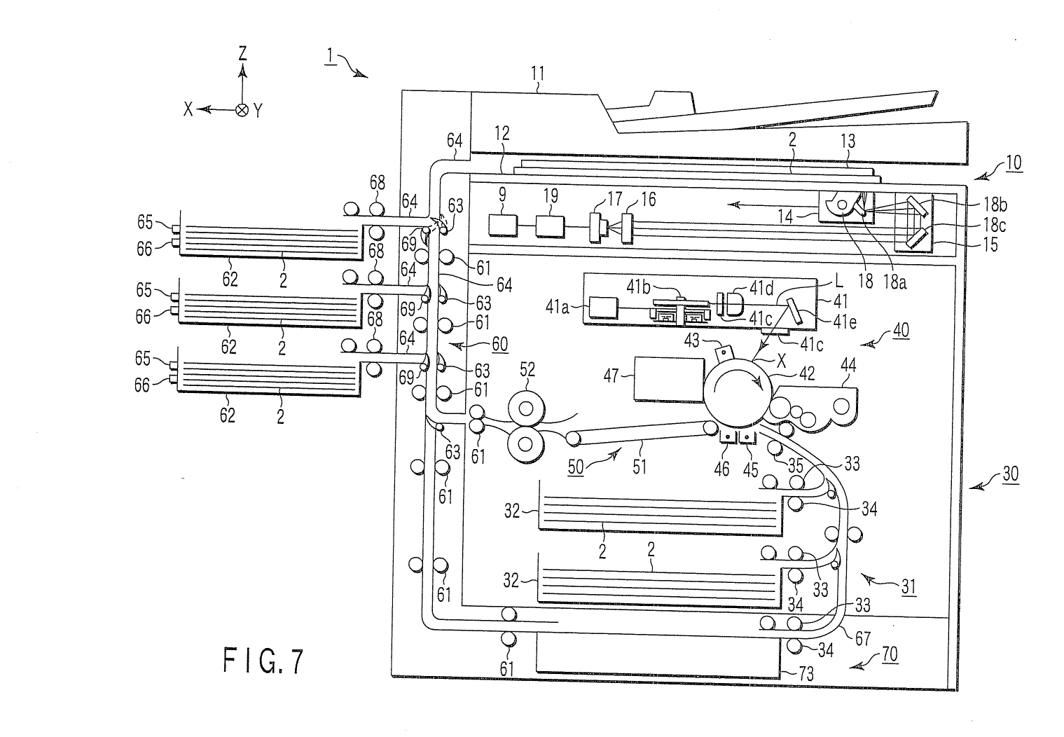

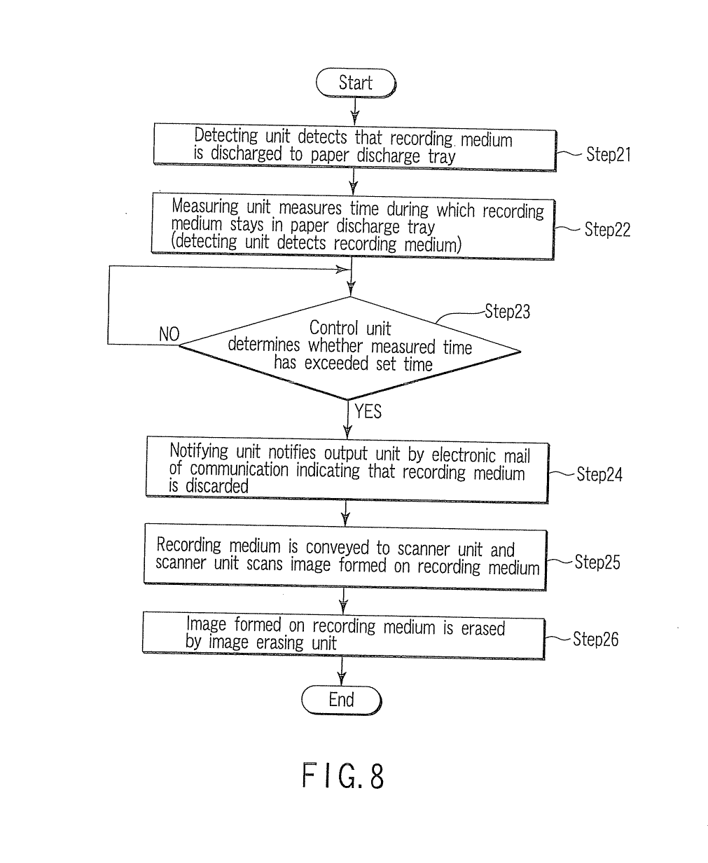

A third embodiment according to the invention will be explained with reference to FIGS. 7 and 8. FIG. 7 is a schematic diagram schematically showing a structure of an image forming apparatus in this embodiment. FIG. 8 is a flowchart in reusing a recording medium having an image formed thereon in this embodiment. Components same as those in the first embodiment described above are denoted by the same reference numerals and signs and detailed explanations of the components are omitted.

Components in this embodiment different from those in the first embodiment will be briefly explained with reference to FIG. 7.

An image in this embodiment is formed on the recording medium 2 by an image forming material containing a color developing compound, a developer, and binder resin. The color developing compound is a precursor compound of pigment forming developed color images such as a character and a figure. For example, the color developing compound is leucoauramines. The developer is a compound for causing the color developing compound to develop a color according to an interaction with the color developing compound. For example, the developer is phenolics. The binder resin is resin for dispersing the color developing compound and the developer in a color developing state. The binder resin has a characteristic that the binder resin is compatible with the color developing compound at the time of heating and does not have affinity with the developer.

The discarding unit 70 in the first embodiment is the shredder 71. However, the discarding unit 70 in this embodiment is an image erasing unit 73 that erases an image formed on the recording medium 2. A reuse conveying path 67, which is a part of the conveying path, is provided between the image erasing unit 73 and the paper feeding unit 31.

When the measured time has exceeded the set time, the control unit 5 drives the switching units 63 and the switching units 69 to switch a conveyance destination of the recording medium 2. Consequently, the recording medium 2 is conveyed to the scanner unit 10 through the paper discharging and conveying path 64. The recording medium 2, on which the image is scanned by the scanner unit 10, is conveyed to this image erasing unit 73 through the paper discharging and conveying path 64.

The image erasing unit 73 grinds and scrapes off the image formed on the recording medium 2 with a not-shown grinding member such as a brush. Subsequently, the image erasing unit 73 heats a small image remaining when the image is scraped off using a not-shown contact-heating type device such as a heat roller. Consequently, the small image remaining on the recording medium 2 and a small image scattering and adhering to the surface of the recording medium 2 when the grinding member grinds the image are erased.

The recording medium 2, from which the image is erased, is conveyed to the aligning roller 35 through the reuse conveying path 67. Consequently, the image is formed again. The recording medium 2 may move from the image erasing unit 73 to the recording media cassette 32 through a not-shown conveying path and stays on standby there in preparation for reuse (by the next image formation).

Processing of a recording medium after image formation in this embodiment will be explained with reference to FIG. 5. Operations from formation of an image on the recording medium 2 to discharge of the recording medium 2 to the paper discharge tray 62 are omitted because the operations are the same as those in the first embodiment described above.

As described above, the recording medium having the image formed thereon is discharged to the paper discharge tray 62.

In that case, as shown in FIG. 3, the detecting unit 65 detects that the recording medium 2 is discharged to the paper discharge tray 62 (Step 21). At this point, the measuring unit 66 starts measurement. Consequently, time during which the recording medium 2 stays in the paper discharge tray 62 is measured by the measuring unit 66 (Step 22). The control unit 5 determines whether the measured time measured by the measuring unit 66 has exceeded the set time set in advance by the setting unit 7 (Step 23).

When the measured time has exceeded the set time in this determination (Step 23: Yes), the notifying unit 9 notifies an output unit by electronic mail that the recording medium 2 is conveyed to the discarding unit 70 and reused (Step 24). The notifying unit 9 may add the recording medium information to the communication indicating that the recording medium 2 is reused and transmit the recording medium information. When the measured time has not exceeded the set time (Step 23: No), the processing returns to Step 23.

Moreover, the control unit 5 drives the switching units 63 and the switching units 69 to switch a conveyance destination of the recording medium 2. Consequently, the recording medium 2 is conveyed to the scanner unit 10 through the paper discharging and conveying path 64. After the recording medium 2 is conveyed to the original stand 12, the scanner unit 10 moves the first carriage 14 and the second carriage 15 in the X axis direction while causing light emitted from the first carriage 14 to scan along the Y axis direction as described above. Consequently, the scanner unit 10 scans the image formed on the recording medium 2 conveyed. The image scanned is stored in the storing unit 19 as described above (Step 25).

The recording medium 2 is conveyed from the original stand 12 to the image erasing unit 73 serving as the discarding unit 70 through the paper discharging and conveying path 64. As described above, the image erasing unit 73 grinds and heats the image formed on the recording medium 2 conveyed. Consequently, the image is erased (Step 26).

The processing from Step 21 to Step 25 is substantially the same as the processing from Step 1 to Step 5 in the first embodiment described above.

As described above, in this embodiment, the image formed by the image forming material is erased to an invisible level by grinding and heating and the recording medium 2, from which the image is erased, is reused.

Consequently, in this embodiment, it is possible to obtain effects same as those in the first embodiment described above.

In this embodiment, since it is possible to reuse the recording medium 2, it is possible to improve efficiency of use of the recording medium 2. This embodiment is effective for recycling of resources.

In the respective embodiments, the discarding unit 70 is provided inside the image forming apparatus. However, the discarding unit 70 may be provided outside the image forming apparatus 1. Moreover, in the respective embodiments, a scanner exclusive for discarded images may be provided separately from the scanner unit 10. This scanner exclusive for discarded images scans, for example, only an image formed on the recording medium 2 immediately before being discarded (e.g., shredded by the shredder 71) as explained in Step 5.

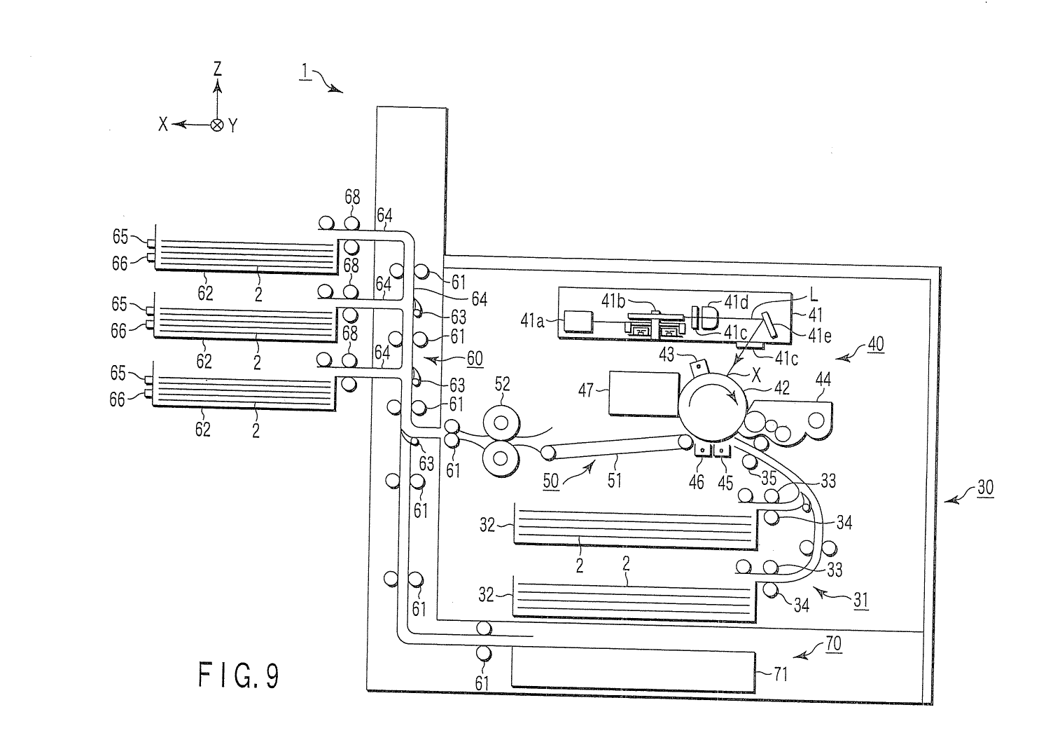

In the respective embodiments, it is possible to provide a scanning function immediately before paper discharge by the scanner unit 10 and an email transmission function by the notifying unit 9 as options. Thus, it is possible to remove these functions. Consequently, in the respective embodiments, it is possible to directly convey the recording medium 2 to the discharging unit as shown in FIG. 9 when the set time has elapsed. Thus, in the respective embodiments, since it is possible to adopt a mechanism specialized for discarding a recording medium, it is possible to constitute the image forming apparatus inexpensively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an image forming unit configured to form an image on a recording medium;
a conveying unit configured to convey the recording medium having the image formed thereon by the image forming unit;
a paper discharge unit to which the recording medium conveyed by the conveying unit is discharged;
a detecting unit configured to detect the recording medium discharged to the paper discharge unit;
a measuring unit configured to measure time during which the detecting unit detects the recording medium; and
a discarding unit configured to discard the recording medium when the time measured by the measuring unit has exceeded a set time set in advance.

2. An image forming apparatus according to claim 1, wherein a plurality of the paper discharging units are provided.

3. An image forming apparatus according to claim 1, wherein the discarding unit includes a shredder that shreds the recording medium.

4. An image forming apparatus according to claim 1, wherein the discarding unit includes a discarding case that is discarded after the recording medium is stored therein.

5. An image forming apparatus according to claim 1, wherein the discarding unit includes an image erasing unit configured to erase the image formed on the recording medium.

6. An image forming apparatus according to claim 5, wherein the image erasing unit erases the image from the recording medium with grinding and heating processing.

7. An image forming apparatus according to claim 1, wherein the detecting unit is provided in the paper discharge unit.

8. An image forming apparatus according to claim 1, further comprising:
a scanning unit configured to scan the image formed on the recording medium; and
a storing unit configured to store the image scanned.

9. An image forming apparatus according to claim 8, wherein the scanning unit scans, when the time has exceeded the set time, the image formed on the recording medium at least one of during a period in which the recording medium is conveyed from the paper discharge unit to the discarding unit and immediately after the image is formed on the recording medium.

10. An image forming apparatus according to claim 8, wherein the image forming unit forms the image stored in the storing unit.

11. An image forming apparatus according to claim 8, wherein the scanning unit includes a scanner.

12. An image forming apparatus according to claim 1, further comprising a notifying unit configured to notify, when the time has exceeded the set time, an output unit that outputted an instruction to form the image on the recording medium to the image forming unit that the discarding unit discards the recording medium having the image formed thereon.

13. An image forming apparatus according to claim 12, wherein the notifying unit further notifies the output unit of recording medium information formed on the recording medium.

14. An image forming apparatus according to claim 12, wherein the notifying unit notifies the output unit by electronic mail that the discarding unit discards the recording medium having the image formed thereon.

15. An image forming apparatus according to claim 12, wherein the output unit includes at least one of a PC selected by a selecting unit or a PC that outputted an instruction to form the image on the recording medium to the image forming unit via a LAN.

16. A recording medium discarding mechanism comprising:
a paper discharge unit to which a recording medium having an image formed thereon by an image forming unit is discharged;
a detecting unit configured to detect the recording medium discharged to the paper discharge unit;
a measuring unit configured to measure time during which the detecting unit detects the recording medium; and
a discarding unit configured to discard the recording medium when the time measured by the measuring unit has exceeded a set time set in advance.

17. A recording medium discarding mechanism according to claim 16, wherein a plurality of the paper discharge units are provided.

18. A recording medium discarding mechanism according to claim 16, further comprising:
a scanning unit configured to scan, when the time has exceeded the set time, the image formed on the recording medium at least one of during a period in which the recording medium is conveyed from the paper discharge unit to the discarding unit and immediately after the image is formed on the recording medium; and
a storing unit configured to store the image scanned.

19. A recording medium discarding mechanism according to claim 16, further comprising a notifying unit configured to notify, when the time has exceeded the set time, an output unit that outputted an instruction to form the image on the recording medium to the image forming unit that the discarding unit discards the recording medium.

20. An image output system comprising:
an image forming unit configured to form an image on a recording medium;
a conveying unit configured to convey the recording medium having the image formed thereon by the image forming unit;
a paper discharge unit to which the recording medium conveyed by the conveying unit is discharged;
a detecting unit configured to detect the recording medium discharged to the paper discharge unit;
a measuring unit configured to measure time during which the detecting unit detects the recording medium;
a discarding unit configured to discard the recording medium when the time measured by the measuring unit has exceeded a set time set in advance; and
an output unit configured to cause the image forming unit to output the image via a LAN.

21. An image output system according to claim 20, wherein a plurality of the paper discharge units are provided.

22. An image output system according to claim 20, further comprising:
a scanning unit configured to scan, when the time has exceeded the set time, the image formed on the recording medium at least one of during a period in which the recording medium is conveyed from the paper discharge unit to the discarding unit and immediately after the image is formed on the recording medium; and
a storing unit configured to store the image scanned.

23. An image output system according to claim 20, further comprising a notifying unit configured to notify, when the time has exceeded the set time, the output unit that the discarding unit discards the recording medium.

24. An image forming method comprising:
forming an image on a recording medium;
conveying the recording medium having the image formed thereon;
discharging the recording medium conveyed;
detecting the recording medium discharged;
measuring time during which the recording medium is detected; and
discarding the recording medium when the time measured has exceeded a set time set in advance.

25. An image forming method according to claim 24, wherein the recording medium is discarded after being shredded by a shredder.

26. An image forming method according to claim 24, wherein the recording medium is discarded after being discharged to a case.

27. An image forming method according to claim 24, wherein the recording medium is discarded after the image formed thereon is erased by grinding and heating.

28. An image forming method according to claim 24, further comprising:
scanning the image formed on the recording medium; and
storing the image scanned.

29. An image forming method according to claim 28, wherein, when the time has exceeded the set time, the image formed on the recording medium is scanned at least one of a period from time when the recording medium is discharged until the recording medium is discarded and immediately after the image is formed on the recording medium.

30. An image forming method according to claim 28, wherein the image stored is formed.

31. An image forming method according to claim 24, further comprising notifying, when the time has exceeded the set time, an output unit that outputted an instruction to form the image on the recording medium that the recording medium having the image formed thereon is discarded.

32. An image forming method according to claim 31, wherein recording medium information formed on the recording medium is notified to the output unit.

33. An image forming method according to claim 31, wherein it is notified to the output unit by electronic mail that the discarding unit discards the recording medium having the image formed thereon.
